(19) United States
(12) Patent Application Publication
(10) Pub. No.: US 2020/0346535 A1
(43) Pub. Date: Nov. 5, 2020

(54) ELECTRIC-POWERED GAS ENGINE REPLACEMENT

(71) Applicant: Blount, Inc., Portland, OR (US)

(72) Inventors: Edgar A. Dallas, Beaverton, OR (US); Jonathan Ziring, Portland, OR (US)

(21) Appl. No.: 16/856,381

(22) Filed: Apr. 23, 2020

Related U.S. Application Data
(60) Provisional application No. 62/841,240, filed on Apr. 30, 2019.

(51) Int. Cl. B60K 1/04; H01M 10/0525; H01M 2/10

(52) U.S. Cl. CPC B60K 1/04; H01M 2/1083; H01M 10/0525

(57) ABSTRACT

Embodiments herein describe an electric powered engine that is self-contained. The engine is configured as a single unit with an adapter plate to match the mounting pattern of a liquid fueled engine equipped to an implement, an output shaft or other power transmission mechanism to match the output shaft or power transmission mechanism of the liquid fueled engine, and/or a cable mount point and associated module to match and translate any control cable inputs of the liquid fueled engine, so that the engine can be directly connected to the implement as a replacement for the liquid fueled engine, without requiring modification of the implement.

### CROSS-REFERENCE TO RELATED APPLICATION

This patent application claims the benefit of U.S. Provisional Application No. 62/841,240, filed Apr. 30, 2019, and entitled “ELECTRIC-POWERED GAS ENGINE REPLACEMENT”, the entire contents of which are hereby incorporated by reference herein.

### TECHNICAL FIELD

Embodiments herein relate to the field of power implements such as lawnmowers, pressure washers, snow throwers, and other such systems, and more specifically, to an electric-powered engine suitable for replacing a gas or other liquid fueled engine on a power implement.

### BACKGROUND

Power implements, such as lawnmowers, log splitters, pressure washers, snow throwers, edgers, and other similar types of power equipment typically use a either a liquid fueled power source, such as a gas or diesel powered engine, or an electric power source, such as one or more electric motors, to supply power. Electric powered implements typically fall into two categories: corded, and non-corded, each with advantages and disadvantages. Both corded and non-corded electric implements typically offer significant benefits over liquid-fueled implements, such as lack of noxious fumes, low to no CO₂ emissions, no dealing with volatile flammable liquids, quieter operation, relatively low maintenance, and little to no tuning required to obtain optimal results. Corded implements offer power comparable to (or, in some cases, better than) liquid fueled implements, potentially unlimited run times, and in some cases, comparable or lighter weight. However, as the name suggests, such implements rely upon a cord running from the implement to an external power source, either a building's power supply or a generator. Non-corded/cordless implements remove the need for a cord and external power supply. However, battery powered implements are run-time limited, the battery being similar to a fuel tank on liquid-fueled implements. Depending upon the battery technology employed, a battery-powered implement that has sufficient battery capacity to approach the run time and/or power of a comparable liquid fueled implement may be substantially heavier than the liquid fueled counterpart, substantially more expensive, or both.

Increasingly, however, advances in cordless electric technology have overcome many of the aforementioned disadvantages, and consequently battery powered implements are beginning to supplant liquid fueled implements. The advent of high-power density battery packs (such as packs using Lithium-Ion technology) and brushless motors have enabled the production of implements that are comparable in weight to liquid fueled implements while also offering comparable (or better) power and run time. Further, the initial acquisition cost of such implements is typically only modestly more expensive than a comparable liquid fueled implement, and is usually offset over the life of the implement due to the cheaper cost to recharge the battery pack compared to liquid fuel costs. When the ongoing maintenance costs for a liquid fueled engine are also considered, over the lifetime of a cordless electric powered implement the total cost of ownership may be cheaper than a comparable liquid fueled implement.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a block diagram of the various components of an example electric-powered engine configured to replace a liquid fuel-powered engine on an implement, according to various embodiments.

FIG. 2 is a depiction of an example liquid fuel-powered engine as currently known in the art.

FIG. 3 is a depiction of the example electric-powered engine of FIG. 1, according to various embodiments.

FIG. 4 is a block diagram of an example computer that can be used to implement some or all of the components of the system of FIG. 1, according to various embodiments.

FIG. 5 is a block diagram of a computer-readable storage medium that can be used to implement some of the components of the system or methods disclosed herein, according to various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Liquid fueled engines, such as gasoline or diesel engines, typically come from their manufacturer as a complete, integrated unit, including a fuel tank and associated hoses, starter attachment, governor, and other systems necessary to the safe and controlled operation of the engine. To operate with the implement, such an engine need only be bolted to the implement via a mounting plate with a pre-established mounting pattern, the operating components of the implement secured to the engine's drive shaft, and one or more control cables, typically mechanical in nature, attached to the implement for engine starting, operation, and shutdown. The implement is thus designed around the engine's integrated form factor and associated specifications. This approach is typically taken regardless of whether the implement manufacturer is also the engine manufacturer, or if the implement manufacturer purchases pre-built engines from a third-party supplier. This approach offers a practical benefit: The engine can be easily removed from the implement if necessary for service and overhaul. Where the engine has reached the end of its useful life, the engine can simply be swapped for a new (possibly upgraded) engine, so long as the replacement engine conforms to the same mounting specifications as the original engine.

In contrast, manufacturers of implements that are powered by electricity (either battery or via cord) often design the implement and power system together in a more integrated fashion. Such implements may place various components of the electric engine at a variety of different locations on the implement depending on where a given component most logically should be placed, connecting the components via various cables and/or wires. For example, the motor of the engine may be located proximate to where the power will be used, to avoid additional equipment needed to transfer power from an engine whose placement is constrained by engine package size. Some implements may include multiple motors placed at different locations, e.g. on an electric self-propelled lawn mower, one motor may drive the cutting blade or blades, while one or more additional motors may drive the driving wheels or other mechanisms. The control mechanism for the motor(s) may be placed distant from the motors, such as near an operator control panel and/or operating display. The display or control panel may be located near operator controls, or in another place convenient to be viewed and/or manipulated by an operator. The power source, such as a battery pack or packs, may be located any place or places having suitable space on the implement, and may be selected with consideration to weight, balance, and handling of the implement, accessibility for ease of charging and/or changing, and protection from possible damage during implement use.

As the technology of electric power advances to where not only weight, but the runtime and power is comparable to liquid-fueled power, the advantages of electric power over liquid-fueled power (e.g., low maintenance, quiet operation, lack of exhaust emissions, low to no CO2 generation) make electric power for implements a superior choice. However, because of their typically integrated design, replacing a liquid fueled engine on an implement and retrofitting it to operate with electric power can be a time-consuming and involved process, requiring skill in mechanical and electrical systems. Extensive modification of the implement frame and working components may be necessary to provide mounting points and routing for the various components of an electric power system. Typically, the time and expense involved makes such a retrofit infeasible when compared with the cost of purchasing an implement designed for electric power from inception.

An implement may have a useful life that exceeds that of its engine, particularly where the engine is liquid fueled. As discussed above, such an implement would typically be fitted with a new liquid fueled engine of comparable specifications to the old engine. Replacement of the entire implement in favor of an electric powered implement may be prohibitively expensive and wasteful, particularly where the implement itself has a substantial useful life remaining. Embodiments disclosed herein include an electric powered engine in a form factor approximating that of a liquid fueled engine, and adapted to be a drop-in replacement. The electric powered engine will replace a liquid fueled engine, accept all existing controls, and provide comparable functionality and performance to the engine being replaced. Such an electric powered engine can enable operators of existing liquid fuel powered implements to gain many of the advantages of an electric powered implement, but without the expense of purchasing a new electric powered implement, and without having to discard an otherwise useful implement or refit it with a new liquid fueled engine.

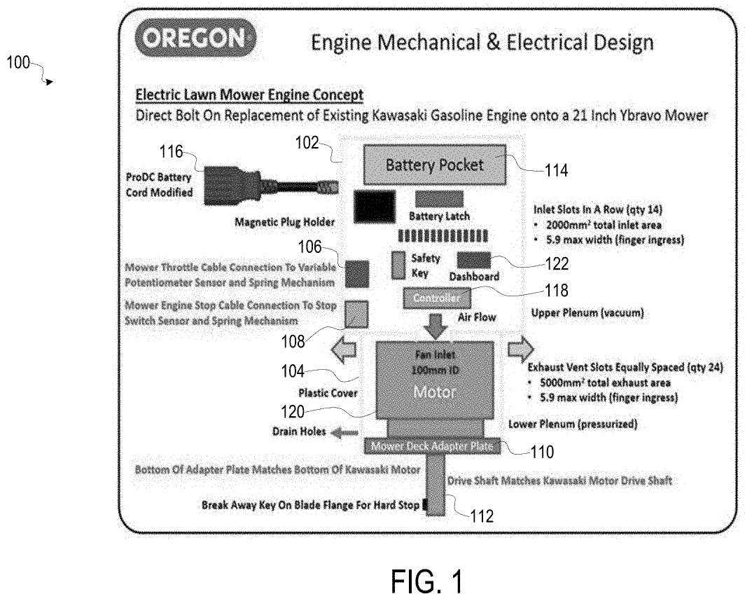

FIG. 1 diagrammatically depicts the various components of an electric-powered engine 100 configured to be a direct replacement in an implement for various types and brands of existing liquid fuel-powered engines. In the depicted embodiment, engine 100 includes a power and control portion 102, which is coupled to a motor and drive portion 104. The combined portions 102 and 104 present a unified package similar in form to a liquid fueled engine, sized and configured to be attached to an implement similar to a liquid fueled engine. It should be understood that the combined portions 102 and 104 are logical distinctions. In various embodiments, the components of portion 102 and portion 104 may be located or arranged within engine 100 in any suitable fashion to achieve an engine 100 package that is a suitable drop-in replacement for the liquid-fueled engine of the implement for which engine 100 is designed.

In the disclosed embodiment, power and control portion 102 includes a first control connection 106, a second control connection 108, a battery pocket 114, one or more operator controls 122, and a motor controller 118. Motor and drive portion 104, in the depicted embodiment, includes an adapter plate 110, a power output shaft 112, and a motor 120 that mechanically drives the power output shaft 112.

First control connection 106 and second control connection 108, in embodiments, are configured to accept various control cables, or other mechanical control inputs, on a liquid fuel-powered implement. While in the example embodiment, the mechanical control inputs correspond to throttle and engine stop controls, other embodiments may accept additional and/or different controls. For example, first control connection 106 may be configured to accept an implement throttle control cable that is used to control the speed and power delivery of the engine. In contrast to a liquid fueled engine where the throttle cable would actuate a throttle plate on a carburetor to adjust engine speed, first control connection 106 connects the throttle cable to a variable potentiometer or other similar position sensor or encoder, that allows the selected power of engine 100 to be varied, e.g. ramping up or down of a throttle. In some embodiments, the sensor or encoder, when actuated by the throttle cable, sends a varying signal to motor controller 118, which in turn is electrically connected to motor 120 and drives motor 120 to a speed corresponding to the sensed position of the throttle cable.

Similarly, second control connection 108 may be configured to accept an implement stop cable or switch, used to stop the engine either when use of the implement has discontinued and/or in the event of an emergency where the engine must be immediately arrested. For liquid fueled engines, the method of stopping the engine may vary. When used with engine 100, in some embodiments, the cable or switch may connect to a switch or sensor that sends a signal to motor controller 118 to cut power to motor 120, or configure motor 120 to provide a braking force, such as configuring motor 120 to act as a generator, e.g. regenerative braking. In other embodiments, the switch or sensor may interrupt or disconnect the battery in battery pocket 114, to ensure that motor 120 is de-energized. In still other embodiments, the switch or sensor may cause engine 100 to engage an electrical or mechanical blade brake mechanism.

The nature of first control connection 106 and second control connection 108 may vary depending upon the specifics of a given implement. In some embodiments, first control connection 106 and/or second control connection 108 may be mechanical cables that convey a push/pull movement as the connected control is actuated by an implement operator. These cables may further be equipped with springs (such as may be used to bias an emergency stop cable into a failsafe position), brackets, levers, and/or any other mechanisms that allow the cable to interface with engine 100. In other embodiments, first control connection 106 and/or second control connection 108 may be electrical cables, which may be able to directly interact with a switch or potentiometer on engine 100. Other implementations may use hydraulic, pneumatic, or any other means for transmitting control actuations to engine 100.

While engine 100 is depicted with first and second control connections 106 and 108, other embodiments may have fewer or more control connection points, depending upon the nature of the implement and associated engine. The nature of the control connections may vary depending upon the type of mechanical movement or actuating being detected, and may vary from connection to connection on a given embodiment of engine 100.

In the depicted embodiment, motor and drive portion 104 includes an adapter plate 110. Adapter plate 110 provides various mounting points that allows engine 100 to be securely attached to the implement. Adapter plate 110 may be configured to match the mounting pattern of existing liquid fueled engines, in terms of number of holes, placement of holes, plate thickness, and/or any other dimensions needed to accurately match a given liquid fueled engine model. In embodiments, the mounting plate pattern may be selected with respect to the make(s) and model(s) of engine(s) that may be equipped to the implement or implements to which engine 100 is intended to be used. In other embodiments, adapter plate 110 may be configured to accommodate a pulley or sprocket wheel, which may be fitted to output shaft 112 to allow engine 100 to provide power to various implement mechanisms, such as a series of drive wheels and/or a transmission, where the implement is self-propelled, or to operate other auxiliary mechanisms.

Engine 100 may be manufactured in a variety of sizes and with a variety of mounting plate patterns to allow retrofitting to a variety of implements that may allow for multiple engine models. In other embodiments, adapter plate 110 may be interchangeable on a given engine 100, to allow a single engine 100 to be adapted to implements that may use different makes and/or models of liquid fueled engines. Thus, engine 100 may used to replace a number of different models of liquid-fueled engine on a variety of implements, accomplished by swapping in the appropriate model of adapter plate 110.

Motor 120 may be any model appropriate to achieve a specified power output of engine 100. The specified power output may vary depending upon the intended use or uses of engine 100. For example, where an implement is a walk-behind lawn mower, motor 120 may be selected to deliver power comparable to a 5 or 6 horsepower gasoline engine typically found on such mowers. In contrast, where an implement is a hand tool such as a string trimmer, motor 120 may be selected to deliver power comparable to a relatively small two-cycle engine, possibly up to 1 horsepower. Motor 120 may be implemented using any suitable technology, including brushed or brushless technologies, universal motor, DC only, etc. Further, motor 120 may deliver power at an RPM greatly in excess of a liquid fueled engine, or at a significantly slower RPM than a liquid fueled engine, but achieve a speed comparable to the liquid fueled engine the engine 100 is intended to replace. In such embodiments, motor 120 may be equipped to a gear box or other type of reduction or conversion drive to convert the motor's native RPM and torque into an RPM and torque profile that approximates the power output of the liquid fueled engine being replaced.

Motor 120 delivers its power to an output shaft 112 (which may be considered a power take off), which, in embodiments, is sized to approximate the liquid fueled engine being replaced. In addition to comparable dimensions, e.g. length and outer diameter, the shaft 112 may include other necessary features present on the liquid fueled engine, such as a keyway, threaded bore, specific materials hardness, etc. These and/or other features may be used to engage with various implement mechanisms, such as power take off (PTO) attachments including cutting attachments, blades, drive wheels, and/or other implement mechanisms that require power to function. The specific features that may be present on output shaft 112 will depend upon the specifics of a given implement and/or any powered attachments of the implement. Examples of attachments may include pulleys, belt drives, gears, chain drives, couplings, pumps (such as hydraulic or pneumatic pumps), directly-attached blades, fans, or other rotary attachments, gear boxes, transmissions, and/or any other attachment adapted to a given function of an implement. In some embodiments, such as where engine 100 may be useable with a variety of different types of implements that can have different types of powered attachments, output shaft 112 may include additional features that are not required or used by a given implement.

Output shaft 112 may deliver power from motor 120 in a variety of different fashions, depending upon the requirements of a given implement. Such methods may include direct shaft rotation, such as a cutting blade secured to the output shaft 112, or indirect methods, such as rotating a drive pulley and belt, a drive sprocket and chain, a gear drive to a secondary transmission shaft, a gear directly to a secondary or accessory gear, via hydraulic power, such as via a pump driven by engine 100, which is connected by hydraulic lines to one or more accessories, or a combination of any of the foregoing.

Referring back to power and control portion 102, the power and control portion 102 may further include a controller 118. Controller 118, in embodiments, is configured to operate motor 120 in response to inputs from first control connection 106 and/or second control connection 108, so that motor 120 outputs power at least comparable to the liquid fueled engine it is intending to replace. In other embodiments, controller 118 may cause motor 120 to output power that exceeds, or is less than, a comparable liquid fueled engine. Controller 118 receives power from a battery pack installed into battery pocket 114 (or other power source), and modulates it as necessary to control the speed and power delivery of motor 120. The manner in which controller 118 modulates power to motor 120 may depend upon the nature of motor 120. For example, where motor 120 is a brushed DC motor that is self-commutating, controller 118 may simply need to vary the amount of power delivered to control the speed of motor 120. Where motor 120 is a brushless DC motor, controller 118 may need to output a multi-phase signal and provide electronic commutation.

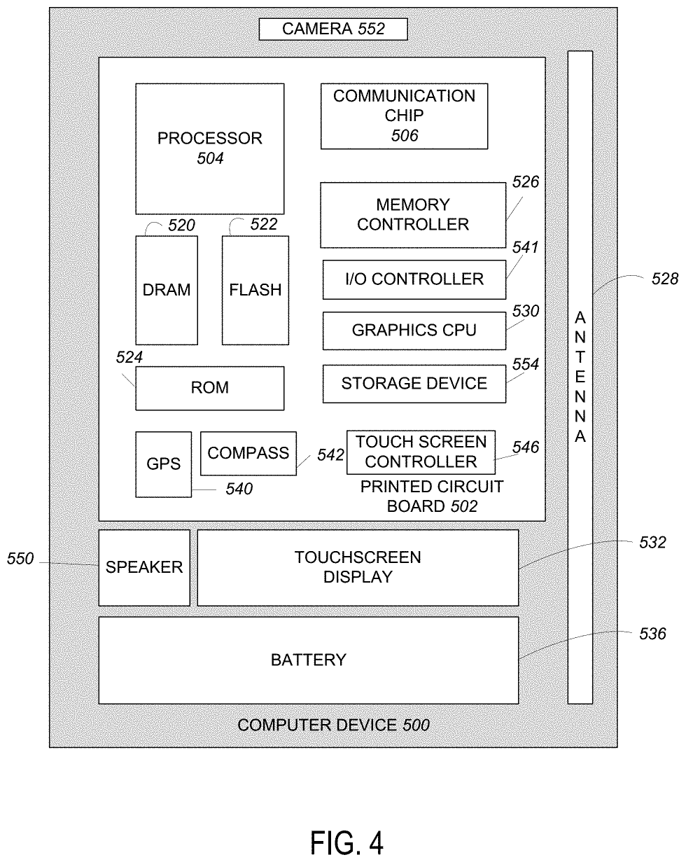

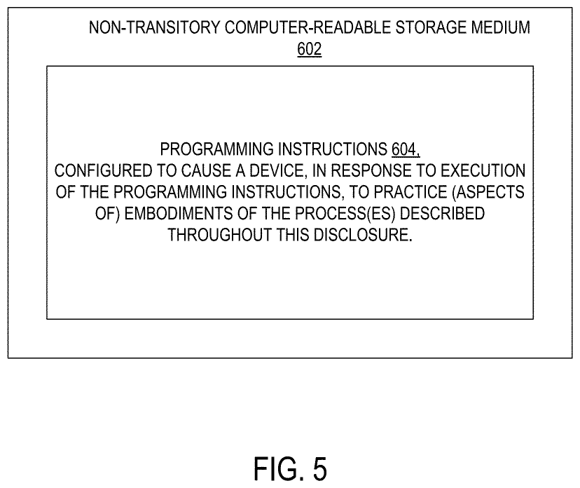

Controller 118 may control the power flow to motor 120 using any suitable method appropriate to the power source and motor type. In some embodiments, controller 118 may continuously vary the voltage and/or current to motor 120. In other embodiments, controller 118 employs a pulse-width modulation scheme to simulate a varying voltage and/or current. Controller 118 may be implemented as software, hardware, or a combination of both. Controller 118 may be implemented as one or more electronic controllers, such as a microprocessor, a microcontroller, discrete circuitry, a combination of the foregoing, or some other device offering similar functionality. Some embodiments may implement some or all of controller 118 using a field-programmable gate array (FPGA), application-specific integrated circuit (ASIC), or another similar technology. In some embodiments, controller 118 may include a computer-readable medium such as a memory storage unit containing instructions capable of being executed by a processing unit that is part of the control system. Controller 118 should be understood as a logical block, and may, in various embodiments, be implemented by one or more discrete modules, such as a processor and an electronic speed controller.

Where controller 118 is implemented using programmable technology, such as a microcontroller or a computer device 500, discussed below with respect to FIG. 4, controller 118's behavior may be governed by firmware or software, such as programming instructions 604 stored on a storage medium 602, discussed below with respect to FIG. 5. Such firmware may configure the controller 118 to create an operating profile of motor 120 to cause engine 100 to approximate or match the power output curve, including speed and torque, of the liquid-fueled engine that is being replaced. In some embodiments, the firmware of controller 118 may be replaced, updated, or upgraded, such as to allow the power output curve of engine 100 to be adjusted to fit a variety of liquid-fueled engines. Operating parameters that may be adjusted by loading an appropriate firmware to controller 118 may include, but are not limited to, power output, torque, RPM, rotational direction, blade stop time/blade braking behavior, and response curves to control inputs (such as the throttle). Controller 118 may also be configured to adjust operation of accessories, such as a blade clutch or drive wheels/transmission.

Controller 118 may interface with one or more operator controls 122, which can include a display, dashboard, and/or one or more switches or keys. In the depicted embodiment in FIG. 1, a dashboard is shown, which may be configured to inform the operator of relevant engine 100 parameters, such as battery capacity/remaining charge, engine 100 run time, current power delivery amount, motor temperature, motor load, overload conditions, time remaining until full battery charge, and any other relevant information about engine 100. Further, a safety key is shown, which may allow a battery or other power source to be disconnected from controller 118 and/or motor 120. Other controls may be present that are not pictured, e.g. battery check, throttle, stop/run switch, etc., depending upon the specific implementation of engine 100.

As discussed above, controller 118 can receive power from a battery installed into a battery pocket 114. The battery, in some embodiments, may be a high power density type, such as a Lithium-Ion pack. In other embodiments, the battery may use another suitable chemistry, such as lead-acid, or nickel-metal-hydride (NiMH). The battery may be removable and may be secured into battery pocket 114 by a battery latch or latching mechanism, as depicted in FIG. 1. The selection of battery chemistry and size may depend upon the nature of the intended implements to which engine 100 may be equipped.

In some embodiments, a battery can be charged while installed into battery pocket 114 via an external power source that connects via power connector 116. Power connector 116 may insert into a receptacle on power and control portion 102, in various embodiments, which may be made magnetic to allow for easy connection and to prevent damage if the power connector 116 is inadvertently pulled. Power and control portion 102, in embodiments, may include charging circuitry to manage charging of a battery inserted into battery pocket 114. In other embodiments, power connector 116 may include charging circuitry, or may attach to external charging circuitry. In still other embodiments, engine 100 may forego a battery pocket 114 or may be operable without a battery present, where power connector 116 may act as a power delivery cord, to render engine 100 and an associated implement as a corded tool.

Finally, power and control portion 102 and motor and drive portion 104 may include air handling features, such as vents, plenums, and fans, to maintain correct operating temperatures for internal components, such as motor 120, controller 118 (as well as any associated electronic speed control module), any battery packs, and/or any other temperature-sensitive internal components of engine 100. The placement of such vents and plenums may be configured to approximately match the air handling and flow of the liquid fueled engine that engine 100 is intended to replace.

It should be understood that FIG. 1 depicts merely one possible embodiment of engine 100, and is schematic in nature; it is not intended to depict every possible component of engine 100. Other embodiments may have more components than those depicted, or may omit one or more components.

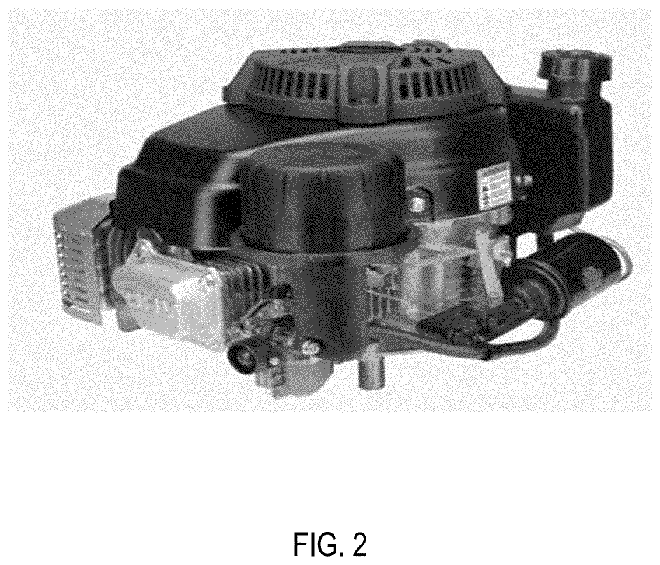

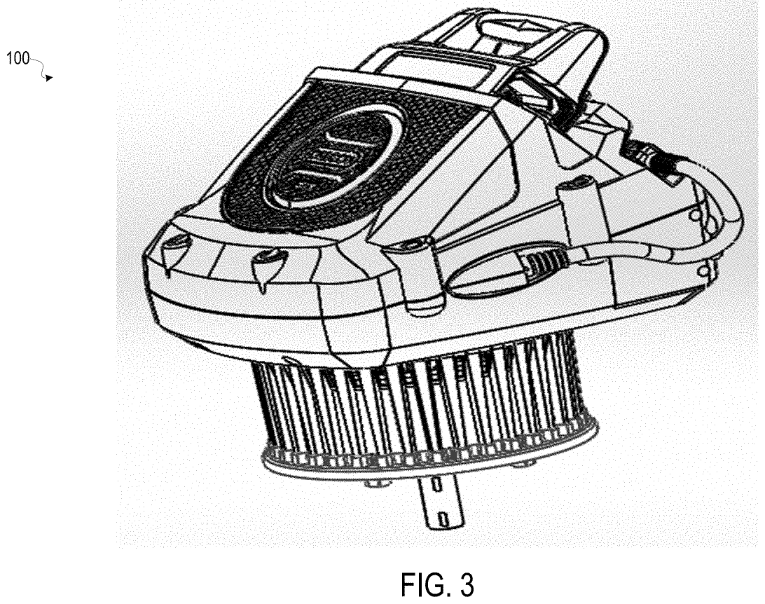

FIGS. 2 and 3 depict a liquid fueled engine (FIG. 2) and an engine 100 according to the various embodiments described herein, for purposes of illustration and comparison. As may be seen, engine 100 is in a form factor that approximates that of the liquid fueled engine of FIG. 2. Engine 100, configured with a mounting plate with an identical pattern to that of the liquid fueled engine, offers a self-contained drop-in replacement for an implement that is normally equipped with the liquid fueled engine of FIG. 2. Thus, by removing the liquid fueled engine from a given implement, engine 100 can be directly connected to the implement and its associated control mechanisms, such as by being bolted on, without requiring any modification to the implement. For example, engine 100 could be directly mounted to the implement (such as using bolts, screws, nuts, rivets, and/or any other suitable fasteners). Engine 100 may be configured to use the same mounting pattern as the removed liquid fueled engine, potentially including the same or similar fasteners. In embodiments, engine 100 is further connected to existing power take off mechanisms (e.g. blades or cutting attachments driven by the engine), and associated implement control mechanisms, as described elsewhere in this disclosure. Implement control mechanisms may include controls for engine 100 and/or for various implement mechanisms and attachments, e.g. engaging the cutting head, engaging drive wheels, etc. The specific control mechanisms will depend upon the nature of a given implement. Moreover, engine 100 may be selected and/or configured to deliver comparable (or better) power than the liquid fueled engine, allowing the implement to be converted to full electric power. The implement equipped with engine 100 may provide performance at least as good as the liquid fueled engine, with comparable or at least acceptable run times from a battery pack.

FIG. 4 illustrates an example computer device 500 that may be employed by the apparatuses and/or methods described herein, in accordance with various embodiments. As shown, computer device 500 may include a number of components, such as one or more processor(s) 504 (one shown) and at least one communication chip 506. In various embodiments, the one or more processor(s) 504 each may include one or more processor cores. In various embodiments, the one or more processor(s) 504 may include hardware accelerators to complement the one or more processor cores. In various embodiments, the at least one communication chip 506 may be physically and electrically coupled to the one or more processor(s) 504. In further implementations, the communication chip 506 may be part of the one or more processor(s) 504. In various embodiments, computer device 500 may include printed circuit board (PCB) 502. For these embodiments, the one or more processor(s) 504 and communication chip 506 may be disposed thereon. In alternate embodiments, the various components may be coupled without the employment of PCB 502.

Depending on its applications, computer device 500 may include other components that may be physically and electrically coupled to the PCB 502. These other components may include, but are not limited to, memory controller 526, volatile memory (e.g., dynamic random access memory (DRAM) 520), non-volatile memory such as read only memory (ROM) 524, flash memory 522, storage device 554 (e.g., a hard-disk drive (HDD)), an I/O controller 541, a digital signal processor (not shown), a crypto processor (not shown), a graphics processor 530, one or more antennae 528, a display, a touch screen display 532, a touch screen controller 546, a battery 536, an audio codec (not shown), a video codec (not shown), a global positioning system (GPS) device 540, a compass 542, an accelerometer (not shown), a gyroscope (not shown), a speaker 550, a camera 552, and a mass storage device (such as hard disk drive, a solid state drive, compact disk (CD), digital versatile disk (DVD)) (not shown), and so forth.

In some embodiments, the one or more processor(s) 504, flash memory 522, and/or storage device 554 may include associated firmware (not shown) storing programming instructions configured to enable computer device 500, in response to execution of the programming instructions by one or more processor(s) 504, to practice all or selected aspects of the controller 118 described herein. In various embodiments, these aspects may additionally or alternatively be implemented using hardware separate from the one or more processor(s) 504, flash memory 522, or storage device 554.

The communication chips 506 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 500 may include a plurality of communication chips 506. For instance, a first communication chip 506 may be dedicated to shorter range wireless communications such as Wi-Fi and Bluetooth, and a second communication chip 506 may be dedicated to longer range wireless communications such as GPS, EDGE, GPRS, CDMA, WiMAX, LTE, Ev-DO, and others.

In various implementations, the computer device 500 may be a laptop, a netbook, a notebook, an ultrabook, a smartphone, a computer tablet, a personal digital assistant (PDA), a desktop computer, smart glasses, or a server. In further implementations, the computer device 500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 5 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer 500, in response to execution of the programming instructions, to implement (aspects of) controller 118. In alternate embodiments, programming instructions 604 may be disposed on multiple computer-readable non-transitory storage media 602 instead. In still other embodiments, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Moreover, the embodiments described in the various figures may be mixed and matched as appropriate for an intended purpose without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A self-contained electric engine for replacing an existing engine on an implement, comprising:
an electric motor;
a controller electrically coupled to the electric motor;
a control input coupled to the controller; and
a power source coupled to the controller,
wherein the control input is configured to accept a mechanical implement control, and the controller is adapted to control the electric motor output to approximate the power output of the existing engine on the implement.

2. The engine of claim 1, wherein the power source is a battery pack.

3. The engine of claim 2, wherein the power source is a lithium-ion battery pack.

4. The engine of claim 1, wherein the power source is a cord coupled to an external power source.

5. The engine of claim 1, further comprising an adapter plate configured to match a mounting pattern of the existing engine.

6. The engine of claim 5, wherein the adapter plate is further configured to match a mounting pattern of a blade brake control clutch.

7. The engine of claim 5, wherein the electric motor, controller, power source, and adapter plate are equipped in a single housing.

8. The engine of claim 1, wherein the controller is adapted to control the electric motor with a firmware.

9. The engine of claim 8, wherein the firmware is adapted to configure a power profile of the electric motor.

10. The engine of claim 9, wherein the power profile of the electric motor approximates a power profile of the existing engine.

11. The engine of claim 1, wherein the control input comprises a sensor coupled to the controller and configured to detect a status of the mechanical implement control, and wherein the controller is adapted to control the electric motor output based on the detected status of the mechanical implement control.

12. The engine of claim 11, wherein the sensor outputs a variable signal that corresponds to a position of the mechanical implement control.
